(19) United States
(12) Patent Application Publication
(10) Pub. No.: US 2026/0067601 A1
(43) Pub. Date: Mar. 5, 2026

(54) MOUNTING COMPONENT, TRANSDUCER, AND ELECTRONIC DEVICE

(71) Applicant: ROHM Co., LTD., Kyoto (JP)

(72) Inventors: Takashi Naiki, Kyoto (JP); Kenji Goda, Kyoto (JP)

(21) Appl. No.: 19/386,887

(22) Filed: Nov. 12, 2025

Related U.S. Application Data
(62) Division of application No. 18/048,906, filed on Oct. 24, 2022.

(30) Foreign Application Priority Data
Oct. 25, 2021 (JP) 2021-173756

(51) Int. Cl. H04R 1/02; H04R 7/10; H04R 7/18; H04R 17/00

(52) U.S. Cl. CPC H04R 1/025; H04R 7/10; H04R 7/18; H04R 17/00

(57) ABSTRACT

Provided is a mounting component held so as to be capable of attachment and detachment by a mounting machine. The mounting component includes a membrane support, a vibrating membrane connected to the membrane support and displaceable in a membrane thickness direction, and a contact member that is located on the membrane support and is subjected to an upward attractive force by the mounting machine without generating stress leading to shape deformation or breakage of the vibrating membrane during the attachment and detachment.

### CROSS REFERENCE TO RELATED APPLICATIONS

The present application is a divisional application of U.S. patent application Ser. No. 18/048,906, filed on Oct. 24, 2022, which claims priority benefit of Japanese Patent Application No. 2021-173756 filed in the Japan Patent Office on Oct. 25, 2021, the entire contents of which are hereby incorporated by reference.

### BACKGROUND

The present embodiment relates to mounting components, transducers, and electronic devices.

In the past, transducers for transmitting or receiving sound waves or ultrasound waves are known. Transducers are used, for example, as speakers that transmit sound waves, and are mounted on earphones, wearable terminals, and other types of equipment.

For example, JP 2021-044762A discloses a transducer suitable for earphones. This transducer is formed to have a lower through-hole passing through a lower base material in a plate thickness direction and has at least a vibrating membrane facing the lower through-hole across a lower space and a piezoelectric element on the vibrating membrane.

### SUMMARY

By repeatedly applying a driving voltage to a pair of electrodes of the piezoelectric element, the minute vibrating membrane alternately repeats upward displacement and downward displacement together with the piezoelectric element. To be specific, a tip side of the vibrating membrane is displaced so as to warp. The vibration of the vibrating membrane causes the air around the vibrating membrane to vibrate, and the vibration of the air is output as sound waves. A transducer including a minute vibrating membrane is subjected to transportation to an electronic device and attachment and detachment by a mounting machine (mounter) or other machines. For transportation, attachment and detachment of a mounting component such as a transducer, the mounting component is picked up by suction of vacuum pressure and placed at a mounting position, for example. However, when the mounting component is sucked by the vacuum pressure, there is a possibility that the air in the space around the minute vibrating membrane is also sucked, so that stress may be generated in the vibrating membrane, which results in shape deformation or damage of the vibrating membrane, and may affect the accuracy of the displacement of the vibrating membrane due to the driving voltage.

One example of the present embodiment provides a mounting component that suppresses state changes such as breakage, deformation, and changes in characteristics. Further, a transducer which is the mounting component is provided. In addition, an electronic device including the transducer is provided.

In the present embodiment, a mounting machine applies an upward attractive force to a contact member facing an outside of a mounting component to perform attachment and detachment of a transducer without generating stress on the vibrating membrane so that the shape deformation or breakage of the vibrating membrane can be suppressed. One example of the present embodiment is as follows.

One example of the present embodiment is a mounting component attachably and detachably held by a mounting machine, and having a membrane support, a vibrating membrane connected to the membrane support and displaceable in the membrane thickness direction, and a contact member which is located on the membrane support and to which an upward attractive force is applied by the mounting machine without generating stress on the vibrating membrane during the attachment and detachment.

Another example of the present embodiment is a transducer that is the mounting component.

Another example of the present embodiment is an electronic device including the transducer.

According to the present embodiment, a mounting component that suppresses changes in state such as damage, deformation, and changes in characteristics can be provided. Further, a transducer which is the mounting component can be provided. Also, an electronic device including the transducer can be provided.

### BRIEF DESCRIPTION OF THE DRAWINGS

FIG. 1 is a cross-sectional view of a transducer sectioned in the X-direction in a first embodiment;

FIG. 2 is a top view of the transducer in the first embodiment;

FIG. 3 is a cross-sectional view of a transducer of a first modification example sectioned in the X-direction in the first embodiment;

FIG. 4 is a top view of the transducer of the first modification example in the first embodiment;

FIG. 5 is a cross-sectional view of a transducer sectioned in the X-direction in a second embodiment.

FIG. 6 is a top view of the transducer in the second embodiment;

FIG. 7 is a cross-sectional view of a transducer of a first modification example sectioned in the X-direction in the second embodiment;

FIG. 8 is a top view of the transducer of the first modification example in the second embodiment;

FIG. 9 is a cross-sectional view of a transducer of a second modification example sectioned in the X-direction in the second embodiment;

FIG. 10 is a top view of the transducer of the second modification example in the second embodiment;

FIG. 11 is a cross-sectional view of a transducer of a third modification example sectioned in the X-direction in the second embodiment;

FIG. 12 is a top view of the transducer of the third modification example in the second embodiment;

FIG. 13 is a cross-sectional view of a transducer of a fourth modification example sectioned in the X-direction in the second embodiment;

FIG. 14 is a top view of the transducer of the fourth modification example in the second embodiment;

FIG. 15 is a cross-sectional view of a transducer of a fifth modification example sectioned in the X-direction in the second embodiment;

FIG. 16 is a top view of the transducer of the fifth modification example in the second embodiment;

FIG. 17 is a cross-sectional view of a transducer of a sixth modification example sectioned in the X-direction in the second embodiment;

FIG. 18 is a cross-sectional view of a transducer of a seventh modification example sectioned in the X-direction in the second embodiment;

FIG. 19 is a cross-sectional view of a transducer of an eighth modification example sectioned in the X-direction in the second embodiment;

FIG. 20A is an overall view of an earphone which is an example of an electronic device;

FIG. 20B is a diagram illustrating a housing of an earphone, which is an example of an electronic device;

FIG. 21 is a diagram illustrating a configuration of a speaker unit in a mounting example; and

FIG. 22 is a cross-sectional view of an earphone in the mounting example;

### DETAILED DESCRIPTION OF THE PREFERRED EMBODIMENTS

Next, the present embodiment will be described with reference to the drawings. In the illustration of the drawings given below, the same or similar parts are denoted by the same or similar reference signs. However, it should be noted that the drawings are schematic, and a relation between the thicknesses and the planar dimensions of respective components, or other relations, may differ from the actual one. Therefore, specific thicknesses and dimensions should be determined with reference to the following description. In addition, it goes without saying that there are parts with different dimensional relations and ratios also between the drawings.

Further, the embodiments illustrated below are examples of apparatuses and methods for embodying technical ideas, and do not specify the material, shape, structure, arrangement, or other components of each component. Various modification examples can be made to the present embodiment within the scope of the claims.

Specific examples of the present embodiment are as follows.

<1> A mounting component which is attachably and detachably held by a mounting machine, and includes a membrane support, a vibrating membrane connected to the membrane support and displaceable in the membrane thickness direction, and a contact member which is located on the membrane support and to which an upward attractive force is applied by the mounting machine without generating stress leading to shape deformation or breakage of the vibrating membrane during the attachment and detachment.

<2> The mounting component described in item <1>, further including, on the contact member, a cover covering the upper side of the vibrating membrane and being attachable to and detachable from the contact member, in which the attractive force due to vacuum suction is applied to the contact member and the cover during the attachment and detachment.

<3> The mounting component described in item <2>, in which the contact member has a first opening, and the cover covers the first opening.

<4> The mounting component described in item <1>, further including a magnetic body on the contact member, in which the attractive force due to the magnetic force is applied to the contact member and the magnetic body during the attachment and detachment.

<5> The mounting component described in item <4>, further including a first base material on the contact member.

<6> The mounting component described in item <4> or <5>, in which the contact member has a first opening, and the magnetic body surrounds the first opening.

<7> The mounting component described in any one of items <4> to <6>, in which the magnetic body covers the entire upper surface of the contact member.

<8> The mounting component described in any one of items <4> to <7>, in which the magnetic body is located at each of points arranged point-symmetrically with respect to a center of the contact member when viewed in the membrane thickness direction.

<9> The mounting component described in item <4> or <5>, in which the magnetic body is provided on the upper surface of each of the four corners of the contact member.

<10> The mounting component described in any one of items <1> to <9>, further including a second base material having a facing surface facing the vibrating membrane, in which the entire area of the facing surface overlaps the vibrating membrane in the normal direction of the facing surface.

<11> The mounting component described in item <1>, further including a second base material having a facing surface facing the vibrating membrane and a magnetic body disposed between the second base material and the membrane support, in which the attractive force due to magnetic force is applied to the contact member, membrane support, and magnetic body during the attachment and detachment.

<12> The mounting component described in any one of items <4> to <11>, in which the magnetic body includes a coating film made of magnetic ink.

<13> The mounting component described in any one of items <1> to <12>, further including a piezoelectric element having a pair of electrodes and a piezoelectric membrane sandwiched between the pair of electrodes and located on the vibrating membrane.

<14> A transducer which is the mounting component described in any one of items <1> to <13>.

<15> An electronic device including the transducer described in item <14.

In the following description, a transducer is used as an example of the mounting component.

### First Embodiment

### <Transducer>

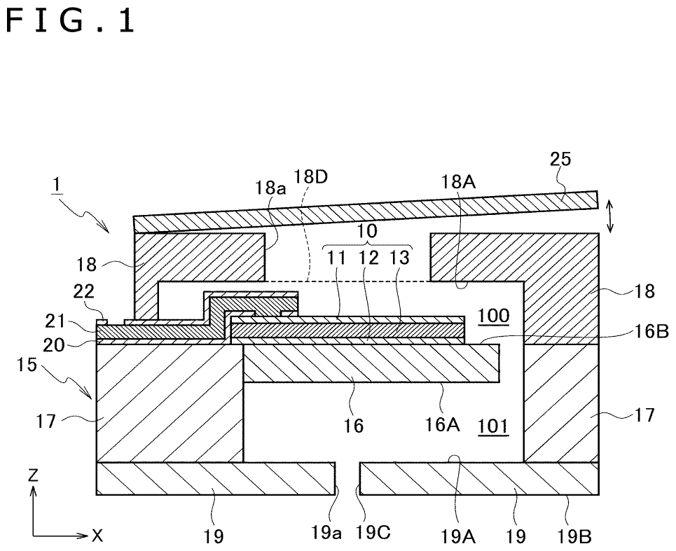

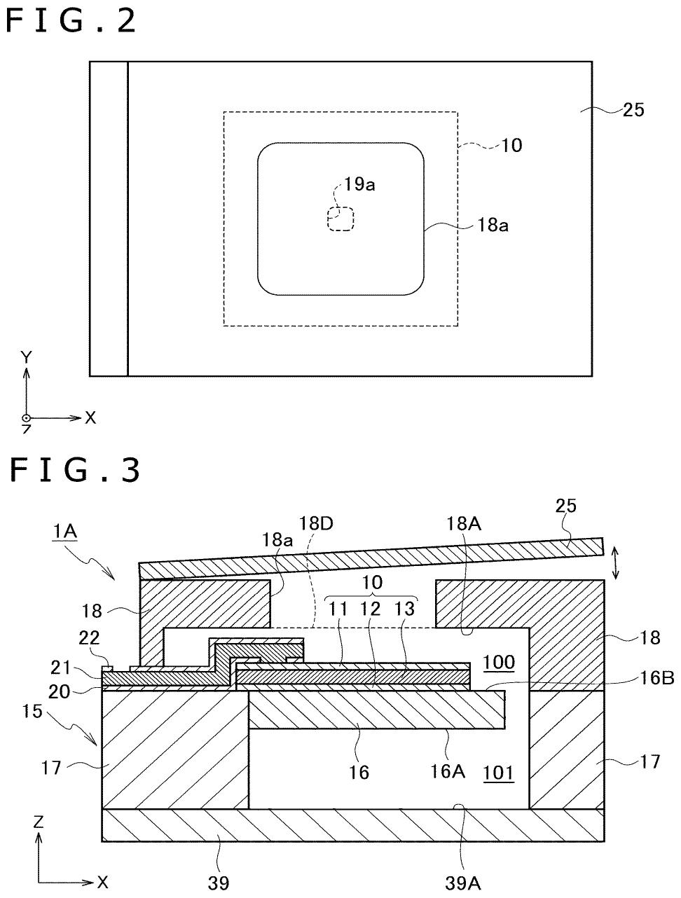

The configuration of a transducer 1 in the present embodiment will be described using FIGS. 1 and 2. FIG. 1 is a cross-sectional view of the transducer 1 sectioned in the X-direction. FIG. 2 is a top view of the transducer 1. The transducer 1 mainly includes a piezoelectric element 10, a membrane body 15, a contact member 18, a base material 19, and a cover 25. To be specific, the membrane body 15 includes a membrane support 17 and a vibrating membrane 16 connected to the membrane support 17 and displaceable in the membrane thickness direction. The base material 19 has a facing surface 19A facing the vibrating membrane 16. The piezoelectric element 10 is arranged on the vibrating membrane 16 and includes a pair of electrodes 11 and 12 and a piezoelectric membrane 13 sandwiched between the pair of electrodes 11 and 12. The contact member 18 can come into contact with the vibrating membrane 16 when the vibrating membrane 16 is displaced in the membrane thickness direction. The cover 25 is located on the contact member 18 to cover the vibrating membrane 16 from above and is attachable to and detachable from the contact member 18. For the attachment and detachment of the transducer 1 to and from an electronic device or other devices by vacuum suction, by covering the upper side of the vibrating membrane 16 with the cover 25, an attractive force directed upward (in the Z-direction to be described later) by vacuum suction of the mounting machine is applied to the contact member 18 and the cover 25, and thus, no stress leading to the shape deformation or breakage of the vibrating membrane 16 is generated, which means that only a small stress that does not lead to the shape deformation or breakage of the vibrating membrane 16 is generated. In the following description, the vertical direction (Z-direction) is defined based on the state of the transducer 1 illustrated in FIG. 1 but the direction in which the transducer 1 is used is not limited. Further, in the present embodiment, the longitudinal direction of the base material 19 is the X-direction, and the lateral direction of the base material 19 is the Y-direction.

The pair of electrodes 11 and 12 and the piezoelectric membrane 13 have a shape corresponding to the shape of the vibrating membrane 16, which will be described later, and are quadrangular in the example illustrated in FIGS. 1 and 2.

Each of the pair of electrodes 11 and 12 is formed by using a thin film of conductive metal such as platinum, molybdenum, iridium, or titanium. The electrode 11 on one side is located above the piezoelectric membrane 13 and connected to an electrode pad which is a circuit pattern for applying a drive voltage to the electrode 11. The electrode 12 on the other side is located below the piezoelectric membrane 13 and connected to an electrode pad which is a circuit pattern for applying a driving voltage to the electrode 12.

The piezoelectric membrane 13 is made of, for example, lead zirconate titanate (PZT). The piezoelectric membrane 13 can be made of aluminum nitride (AlN), zinc oxide (ZnO), lead titanate (PbTiO₃), or other elements, in addition to lead zirconate titanate.

In the transducer 1 configured as described above, the piezoelectric element 10 is provided on the vibrating membrane 16 of the membrane body 15. That is, the lower electrode 12, the piezoelectric membrane 13, and the upper electrode 11 are stacked in this order on the vibrating membrane 16. When drive voltages are applied to the pair of electrodes 11 and 12, respectively, a potential difference is generated between the pair of electrodes 11 and 12. Due to the potential difference, the piezoelectric membrane 13 is deformed, and the vibrating membrane 16 is displaced accordingly.

By repeatedly applying a drive voltage to the pair of electrodes 11 and 12, the vibrating membrane 16 alternately repeats displacements toward a space 100 and toward a space 101. The vibration of the vibrating membrane 16 causes the air around the vibrating membrane 16 to vibrate, and the vibration of the air is output as sound wave.

An insulating film 20 is provided on a part of the upper surface of the piezoelectric element 10, and the electrode 11 is connected to a wiring line 21 through an opening provided on the insulating film 20. Further, an insulating film 22 is provided on the wiring line 21. The wiring line 21 is electrically connected to an electrode pad (not illustrated) through an opening on the insulating film 22. That is, the electrode 11 is electrically connected to the electrode pad through the wiring line 21. Note that, in the present specification or other specifications, “electrically connected” includes the case of being connected via “something having some electrical action. “Here, “something having some electrical action” is not particularly limited as long as the transmission and reception of electrical signals are enabled between objects to be connected. For example, “something having some electrical action” include electrodes, wiring lines, switching elements, resistive elements, inductors, capacitive elements, and other elements having various functions.

The wiring line 21 is formed using a thin film of metal or other elements, for example. For the insulating films 20 and 22, aluminum oxide or other elements can be used, for example.

The membrane body 15 includes the vibrating membrane 16 and the membrane support 17. The membrane body 15 is made of silicon (Si), for example. By etching the back side of the membrane body 15 (the side on which the base material 19 is provided) to form the vibrating membrane 16, the vibrating membrane 16 and the membrane support 17 can be integrally formed.

The vibrating membrane 16 is composed of a thin film and configured to be displaceable in the membrane thickness direction, namely, in the direction normal to the vibrating membrane 16 (up and down direction along the paper surface in FIG. 1: Z-direction, and vertical direction to the paper surface to the front and back sides in FIG. 2: Z-direction). The vibrating membrane 16 has a main surface 16A facing the space 101, which will be described later. The vibrating membrane 16 has a substantially square shape when observed from the direction normal to a plane parallel to the vibrating membrane 16.

The membrane support 17 has a quadrangular-tube-shaped inner peripheral surface that forms the space (cavity) 101. The vibrating membrane 16 is in internal contact with one side of the inner peripheral surface of the membrane support 17, whereby the vibrating membrane 16 is supported by the membrane support 17. The vibrating membrane 16 is connected to the upper end side of the membrane support 17.

Further, the membrane support 17 has a region overlapping with the end portion of the piezoelectric element 10, and the vibrating membrane 16 has a cantilever shape projecting from the membrane support 17. A tip portion of the vibrating membrane 16 is configured as a free end.

The base material 19 has the facing surface 19A facing the vibrating membrane 16, a main surface 19B opposite to the facing surface 19A, and a side wall surface 19C between the facing surface 19A and the main surface 19B. Also, the facing surface 19A of the base material 19 is in contact with the membrane support 17. Further, the facing surface 19A is provided with an opening 19a that passes through the base material 19 and faces the space 101. Further, in the space 101 surrounded by the vibrating membrane 16, the membrane support 17, and the base material 19, the air vibrates due to the displacement of the vibrating membrane 16, and the air is circulated to the outside of the transducer 1 through the opening 19a. Also, as illustrated in FIG. 2, the opening 19a preferably has rounded corners. By rounding the corners of the opening 19a, stress concentration at the corners can be alleviated. The base material 19 is made of Si, for example.

The contact member 18 is formed above the insulating film 22 and above the membrane support 17. The contact member 18 is arranged so as to face the vibrating membrane 16. The contact member 18 has a function of controlling displacement of the vibrating membrane 16. That is, the contact member 18 controls the displacement of the vibrating membrane 16 due to contact of the vibrating membrane 16 or the piezoelectric element 10 on the vibrating membrane 16 with the contact member 18 when the vibrating membrane 16 is displaced toward the space 100.

The distance between a contact surface 18A of the contact member 18 with which the vibrating membrane 16 comes in contact and the vibrating membrane 16 is set based on the displacement of the vibrating membrane 16 when the rated voltage is applied to the piezoelectric element 10 (hereinafter referred to as “maximum displacement”). That is, the contact surface 18A of the contact member 18 is set so that the vibrating membrane 16 or the piezoelectric element 10 (a laminate of these is also called a vibrating body) comes in contact with the contact surface 18A when a displacement larger than the maximum displacement occurs. Due to this, the vibrating membrane 16 or the piezoelectric element 10 will come into contact with the contact surface 18A when a large displacement that exceeds the maximum displacement occurs in the vibrating body due to an impact or other physical phenomenon, without hindering the normal displacement of the vibrating membrane 16 by the piezoelectric element 10.

The shape of the contact surface 18A is formed based on the displacement shape when the vibrating membrane 16 is displaced. As a result, when the vibrating membrane 16 comes into contact with the contact surface 18A, the contact surface 18A has surface contact with the vibrating membrane 16. For example, the contact surface 18A of the contact member 18 arranged in the space 100 may have a hemispherical shape that curves upward. The contact member 18 may also be made of Si or a soft material such as resin, for example.

An opening 18a is provided in the center of the contact member 18. Further, in the space 100 between the vibrating membrane 16 and the contact member 18, the air vibrates due to the displacement of the vibrating membrane 16, and the air is circulated to the outside of the transducer 1 through the opening 18a. When the air flows through the space 100, the distance (gap) between the vibrating membrane 16 and the contact surface 18A of the contact member 18 is sufficient if the vibrating membrane 16 can be vertically displaced, and a smaller size is preferable. For example, the gap is 5 to 30 μm. By reducing the gap, air leakage can be suppressed, and the air can be vibrated efficiently. Also, as illustrated in FIG. 2, the opening 18a preferably has rounded corners. By rounding the corners of the opening 18a, stress concentration at the corners can be alleviated.

The cover 25 can cover the opening 18a of the contact member 18. In other words, it becomes possible to cover or release the opening 18a of the contact member 18 by attaching and detaching the cover 25 on the contact member 18. The arrows illustrated in FIG. 1 indicate that the cover 25 is attachable and detachable. By attaching the cover 25 so as to cover the opening 18a of the contact member 18, even in the case where the transducer 1 is transported by a mounting machine (mounter) or other machines using the suction of the cover 25 by vacuum pressure, when the air in the space 100 and/or the space 101 surrounding the minute vibrating membrane 16 is not sucked or the amount of sucked air is small, only a small stress that does not lead to the shape deformation or breakage of the vibrating membrane 16 is generated so that the shape deformation or breakage can be suppressed. The cover 25 can be removed from the contact member 18 after the transducer 1 is placed at a predetermined position by a mounting machine or other machines that uses vacuum pressure suction.

The attaching/detaching mechanism of the cover 25 is not particularly limited as long as the air in the space 100 and/or the space 101 is not sucked due to suction by the vacuum pressure or the amount of the sucked air is small, and the stress is small enough not to deform or damage the vibrating membrane 16. For example, an adhesive that has a weak adhesive force and allows peeling-off, an adhesive that softens when heat is applied, an adhesive that weakens the adhesive force due to electromagnetic waves such as ultraviolet rays is provided between the cover 25 and the contact member 18, so that the cover 25 can be removed. Alternatively, a physical attachment/detachment mechanism such as a hinge may be provided between the cover 25 and the contact member 18.

The material of the cover 25 is not particularly limited, and may be made of, for example, Si or a soft material such as resin, and a material having a good covering property with respect to the abovementioned adhesive, glue, or material of the contact member 18 is preferably used so that the airtightness of the space 100 is high when the cover 25 is attached.

Since the cover 25 is provided on the contact member 18, the air in the space 100 and/or the space 101 is not sucked by suction by vacuum pressure, or the amount of the suction air is small at the time of transportation, attachment and detachment of the transducer 1 by a mounting machine other machines using suction by vacuum pressure, and only a small amount of stress is generated that does not lead to the shape deformation or breakage of the vibrating membrane 16. As a result, the shape deformation or breakage of the vibrating membrane 16 can be suppressed.

According to such a configuration, a transducer, which is an example of a mounting component, suppressing changes in state such as breakage, deformation, and changes in characteristics can be provided.

The transducer in the present embodiment is not limited to the configuration described above, and various modification examples are possible. Modification examples of the transducer in the present embodiment will be described below.

### First Modification Example

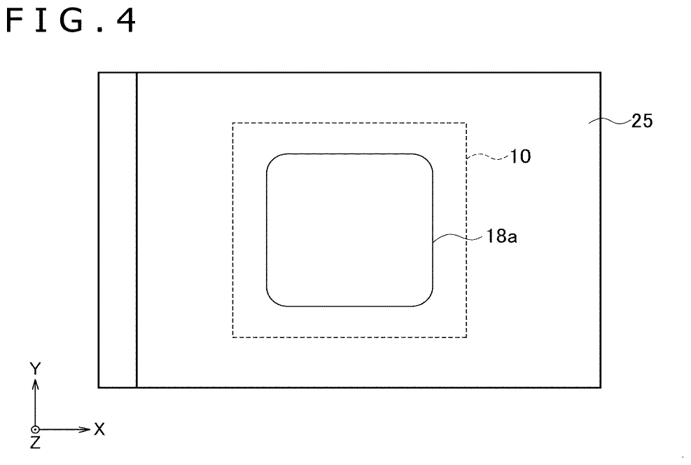

The configuration of a transducer 1A in this modification example will be described with reference to FIGS. 3 and 4. FIG. 3 is a cross-sectional view of the transducer 1A sectioned in the X-direction. FIG. 4 is a top view of the transducer 1A. The difference between the transducer 1A in this modification example and the transducer 1 illustrated in FIGS. 1 and 2 is that the transducer 1A uses a base material 39 having no openings instead of the base material 19. In this modification example, the above description is referenced regarding the points common to the transducer 1 illustrated in FIGS. 1 and 2, and different points will be described below.

The base material 39 is similar to the base material 19 except for the opening 19a of the base material 19 described above. The base material 39 has a facing surface 39A that faces the vibrating membrane 16. The entire area of the facing surface 39A overlaps the vibrating membrane 16 in the normal direction (Z-direction) of the facing surface 39A. Further, the facing surface 39A of the base material 39 is in contact with the membrane support 17. In the space 101 surrounded by the vibrating membrane 16, membrane support 17, and base material 39, the displacement of the vibrating membrane 16 vibrates the air, and the air is circulated through the space 100 to the outside of the transducer 1A. The base material 39 is made of Si, for example.

According to the first modification example, a transducer, which is an example of a mounting component, suppressing changes in state such as breakage, deformation, and changes in characteristics can be provided.

### Second Embodiment

### <Transducer>

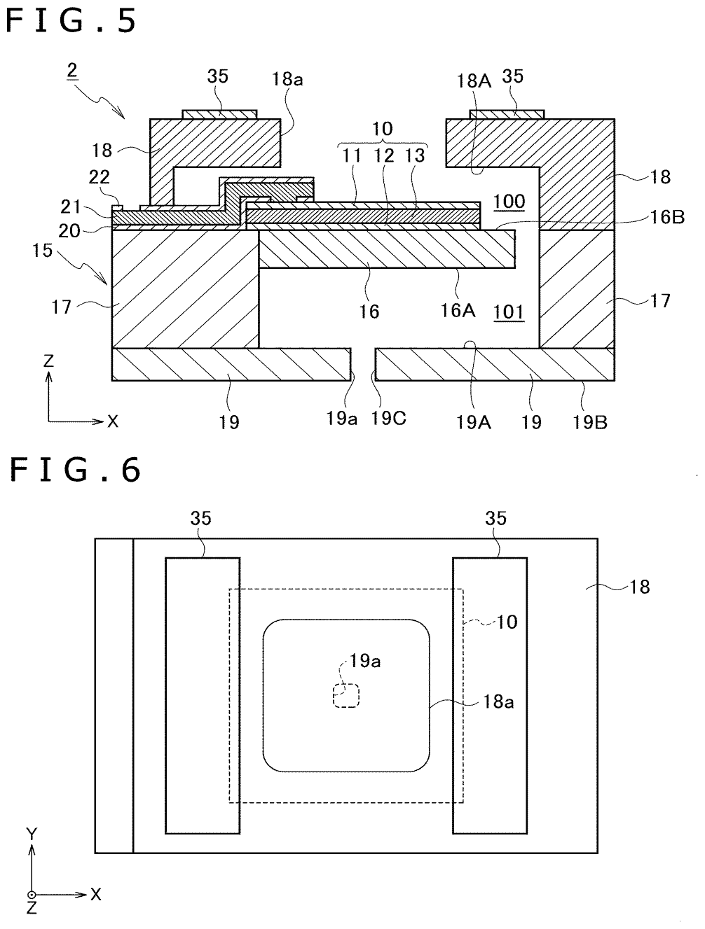

The configuration of a transducer 2 in the present embodiment will be described with reference to FIGS. 5 and 6. FIG. 5 is a cross-sectional view of the transducer 2 sectioned in the X-direction. FIG. 6 is a top view of the transducer 2. The transducer 2 mainly includes the piezoelectric element 10, the membrane body 15, the contact member 18, the base material 19, and the magnetic bodies 35. The difference between the transducer 2 of this embodiment and the transducer 1 of the first embodiment is that the transducer 2 uses the magnetic bodies 35 instead of the cover 25. In this embodiment, the above description is used for reference regarding the points common to the transducer 1 of the first embodiment, and different points will be described below.

The magnetic bodies 35 are located on the contact member 18. For attachment and detachment of the transducer 2, the use of the magnetic bodies 35 makes it possible to apply an attractive force directed upward (in the Z-direction) to the contact member 18 and the magnetic bodies 35 by the magnetic force of the mounting machine without using the vacuum suction as in the first embodiment, stress due to vacuum suction does not occur in the vibrating membrane 16. Therefore, the shape deformation or breakage of the vibrating membrane 16 can be suppressed.

The material of the magnetic bodies 35 is not particularly limited as long as an upward attractive force is generated by the magnetic force and examples thereof include iron, nickel, cobalt, gadolinium, iron oxide, chromium oxide, and ferrite. Moreover, from the viewpoint of easy formation, the magnetic bodies 35 preferably include coating films made of magnetic ink obtained by coating the contact member 18 with magnetic ink containing a material mentioned above.

Also, instead of the magnetic bodies 35, the contact member 18 that generates an upward attractive force by magnetic force may be used. To be specific, the contact member 18 that generates an attractive force due to magnetic force can be obtained by causing the material constituting the contact member 18 to include iron, nickel, cobalt, gadolinium, iron oxide, chromium oxide, ferrite, or other elements to form the contact member 18. When the contact member 18 that generates an attractive force by magnetic force is used, it is sufficient only if the contact member 18 is attracted by the magnetic force generated by the mounting machine at the time of attachment and detachment of the transducer 2, and, for example, only the side of the contact member 18 closer to the mounting machine (for example, the upper side) may have a region containing a material that generates an attractive force due to magnetic force.

Since the transducer 2 has the magnetic bodies 35 provided on the contact member 18, and transportation, attachment and detachment are carried out by a mounting machine other machines that uses magnetic attraction, the vibrating membrane 16 is not stressed by vacuum suction. As a result, the shape deformation or breakage of the vibrating membrane 16 can be suppressed.

According to such a configuration, a transducer, which is an example of a mounting component, suppressing changes in state such as breakage, deformation, and changes in characteristics can be provided.

The transducer in the present embodiment is not limited to the configuration described above, and various modification examples are possible. Modification examples of the transducer in this embodiment will be described below.

### First Modification Example

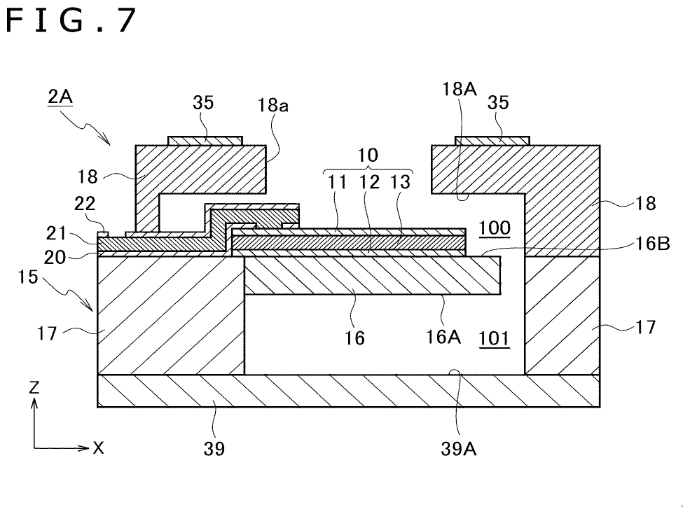

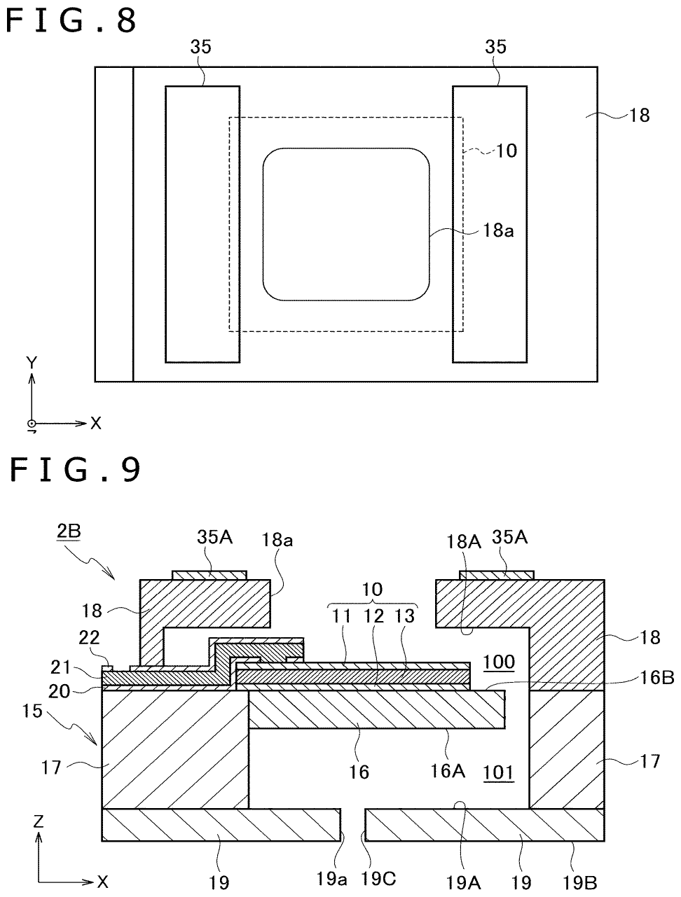

The configuration of a transducer 2A in this modification example will be described with reference to FIGS. 7 and 8. FIG. 7 is a cross-sectional view of the transducer 2A sectioned in the X-direction. FIG. 8 is a top view of the transducer 2A. The difference between the transducer 2A in this modification example and the transducer 2 illustrated in FIGS. 5 and 6 is that the transducer 2A uses the base material 39 having no opening instead of the base material 19. In this modification example, the above description is referenced regarding the points common to the transducer 2 illustrated in FIGS. 5 and 6, and different points will be described below.

Similarly to the transducer 1A in the first modification example of the first embodiment, the transducer 2A preferably uses the base material 39 having no openings because proper airflow can be ensured in the spaces 100 and 101. Furthermore, since the transducer 2A has the magnetic bodies 35 provided on the contact member 18, and transportation, attachment and detachment are carried out by a mounting machine using magnetic attraction, no stress is generated in the vibrating membrane 16 due to vacuum suction. As a result, the shape deformation or breakage of the vibrating membrane 16 can be suppressed.

According to the first modification example, a transducer, which is an example of a mounting component, suppressing changes in state such as breakage, deformation, and changes in characteristics can be provided.

### Second Modification Example

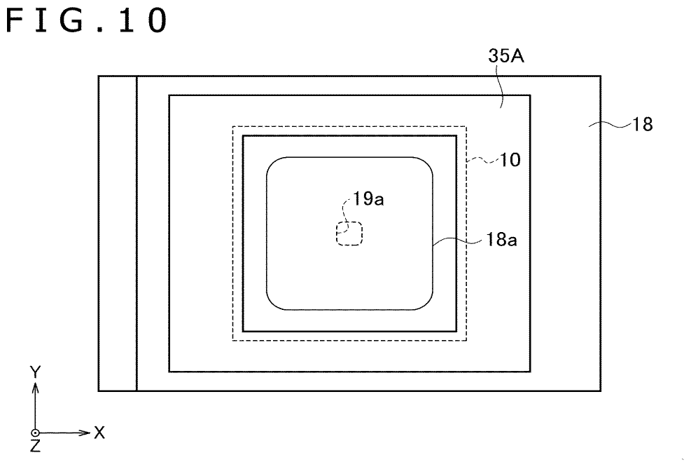

The configuration of a transducer 2B in this modification example will be described with reference to FIGS. 9 and 10. FIG. 9 is a cross-sectional view of the transducer 2B sectioned in the X-direction. FIG. 10 is a top view of the transducer 2B. The difference between the transducer 2B in this modification example and the transducer 2 illustrated in FIGS. 5 and 6 is that the transducer 2B uses a magnetic body 35A surrounding the opening 18a of the contact member 18 instead of the magnetic bodies 35. In this modification example, the above description is used for reference regarding the points common to the transducer 2 illustrated in FIGS. 5 and 6, and different points will be described below.

The material of the magnetic body 35A is not particularly limited as long as an upward attractive force is generated due to the magnetic force, and examples thereof include iron, nickel, cobalt, gadolinium, iron oxide, chromium oxide, and ferrite. From the viewpoint of easy formation, the magnetic body 35A preferably includes a coating film made of magnetic ink which is obtained by coating the contact member 18 with magnetic ink containing a material mentioned above.

By using the magnetic body 35A surrounding the periphery of the opening 18a of the contact member 18, since the contactable area between the magnetic body 35A and the portion of the mounting machine other machines generating the magnetic force can be increased when the transportation, attachment and detachment of the transducer 2B is performed by the mounting machine other machines using magnetic attraction, and the magnetic force (attractive force) applied to the transducer 2B can be dispersed.

According to the second modification example, since the magnetic force (attractive force) is more uniformly applied to the transducer, a transducer, which is an example of a mounting component, suppressing state changes such as breakage, deformation, and changes in characteristics can be provided.

### Third Modification Example

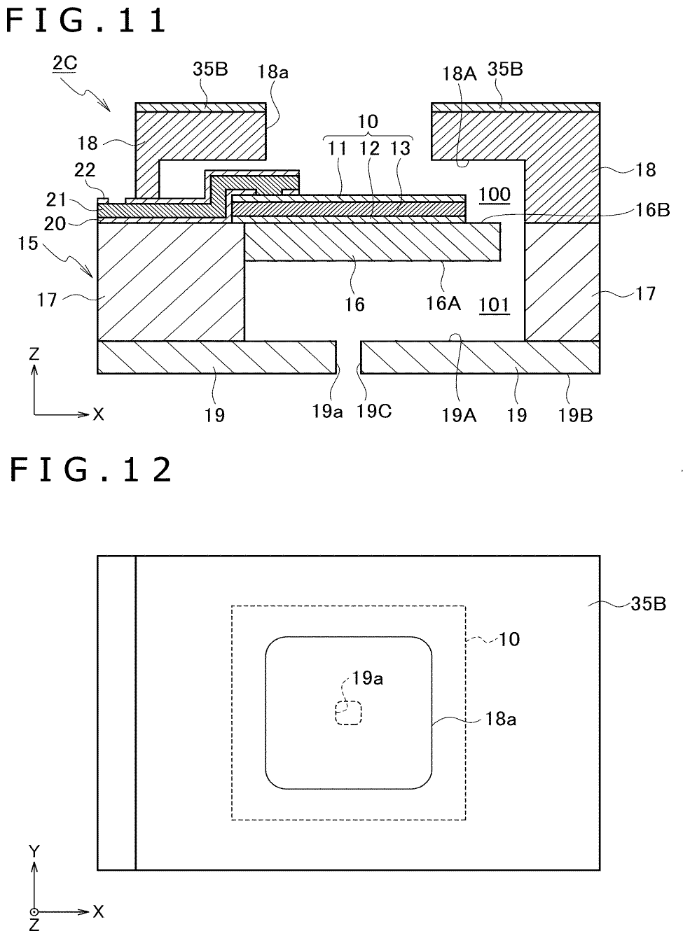

The configuration of a transducer 2C in this modification example will be described with reference to FIGS. 11 and 12. FIG. 11 is a cross-sectional view of the transducer 2C sectioned in the X-direction. FIG. 12 is a top view of the transducer 2C. The difference between the transducer 2C in this modification example and the transducer 2 illustrated in FIGS. 5 and 6 is that the transducer 2C uses a magnetic body 35B covering the entire upper surface of the contact member 18 instead of the magnetic bodies 35. In this modification example, the above description is referenced regarding the points common to the transducer 2 illustrated in FIGS. 5 and 6, and different points will be described below.

The material for the magnetic body 35B is not particularly limited as long as an upward attractive force is generated by the magnetic force, and examples thereof include iron, nickel, cobalt, gadolinium, iron oxide, chromium oxide, and ferrite. Further, from the viewpoint of easy formation, the magnetic body 35B preferably includes a coating film made of magnetic ink obtained by coating the contact member 18 with the magnetic ink containing a material mentioned above.

By using the magnetic body 35B covering the entire upper surface of the contact member 18, the magnetic force (attractive force) applied to the transducer 2C can be dispersed when the transportation, attachment and detachment of the transducer 2C are performed by the mounting machine other machines using magnetic attraction, because the contactable area can be increased between the magnetic body 35B and a portion of the mounting machine other machines where magnetic force is generated.

According to the third modification example, the magnetic force (attractive force) is more uniformly applied to the transducer, and therefore, a transducer, which is an example of a mounting component, suppressing state changes such as breakage, deformation, and changes in characteristics can be provided.

### Fourth Modification Example

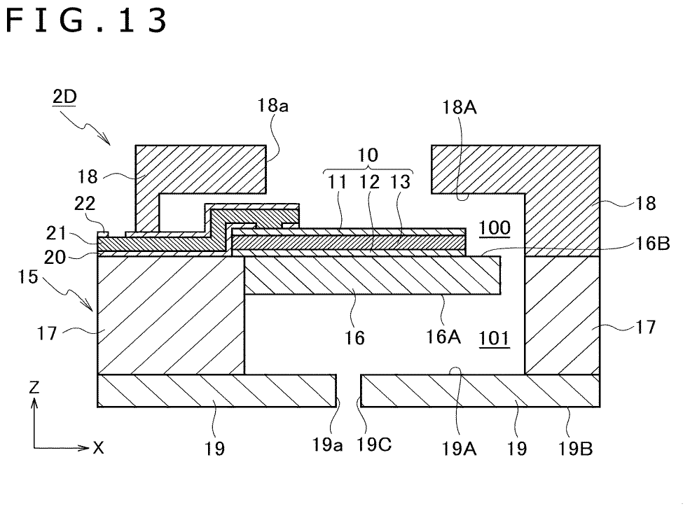

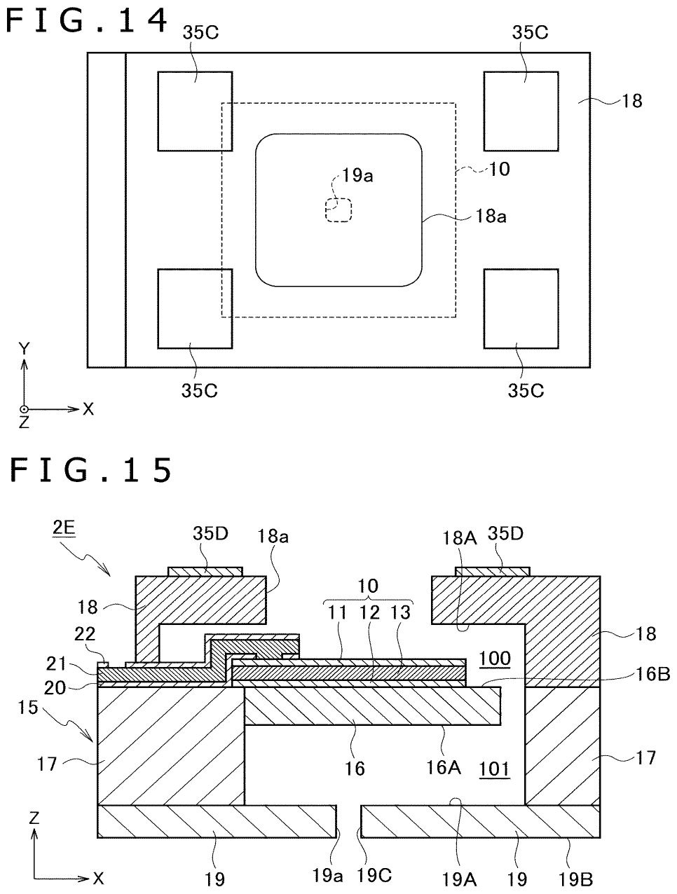

The configuration of a transducer 2D in this modification example will be described with reference to FIGS. 13 and 14. FIG. 13 is a cross-sectional view of the transducer 2D sectioned in the X-direction. FIG. 14 is a top view of the transducer 2D. The transducer 2D in this modification example is different from the transducer 2 illustrated in FIGS. 5 and 6 in that magnetic bodies 35C are provided on the upper surfaces of the four corners of the contact member 18 instead of the magnetic bodies 35. In this modification example, the above description is used for reference regarding the points common to the transducer 2 illustrated in FIGS. 5 and 6, and different points will be described below.

The material of the magnetic bodies 35C is not particularly limited as long as an upward attractive force is generated due to the magnetic force, examples thereof include iron, nickel, cobalt, gadolinium, iron oxide, chromium oxide, and ferrite. From the viewpoint of easy formation, the magnetic bodies 35C preferably includes coating films made of magnetic ink, which are obtained by coating the contact member 18 with magnetic ink containing a material mentioned above.

By using the magnetic bodies 35C provided on the upper surfaces of the four corners of the contact member 18, the contact points between the magnetic bodies 35C and the part generating the magnetic force of the mounting machine other machines can be dispersed when the transportation, attachment and detachment of the transducer 2D conducted by a mounting machine other machines that uses magnetic attraction, so that magnetic force (attractive force) applied to the transducer 2D can be dispersed.

According to the fourth modification example, the magnetic force (attractive force) is more uniformly applied to the transducer, a transducer, which is an example of a mounting component, suppressing state changes such as breakage, deformation, and changes in characteristics can be provided.

### Fifth Modification Example

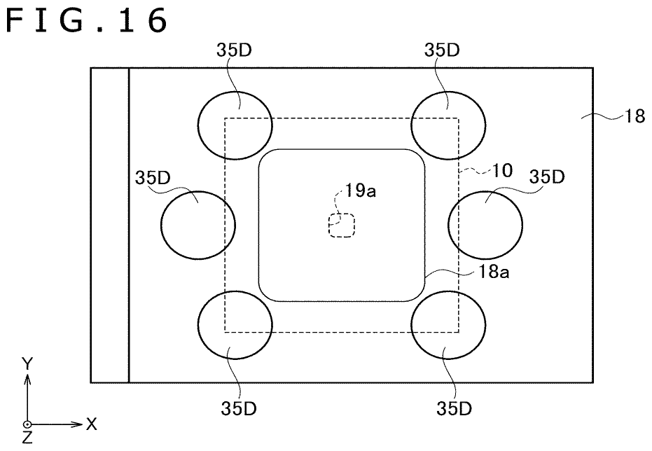

The configuration of a transducer 2E in this modification example will be described with reference to FIGS. 15 and 16. FIG. 15 is a cross-sectional view of the transducer 2E sectioned in the X-direction. FIG. 16 is a top view of the transducer 2E. The transducer 2E in this modification example is different from the transducer 2 illustrated in FIG. 5 and FIG. 6 in that magnetic bodies 35D are provided, which is arranged substantially point-symmetrically with respect to the central portion of the contact member 18 when viewed from the membrane thickness direction (Z direction) instead of the magnetic bodies 35. In this modification example, the above description is referenced for the points common to the transducer 2 illustrated in FIGS. 5 and 6, and different points will be described below.

The material of the magnetic bodies 35D is not particularly limited as long as an upward attractive force is generated by magnetic force, and examples thereof include iron, nickel, cobalt, gadolinium, iron oxide, chromium oxide, and ferrite. Moreover, from the viewpoint of easy formation, the magnetic bodies 35D preferably include coating films made of magnetic ink obtained by coating the contact member 18 with magnetic ink containing a material mentioned above.

By using the magnetic bodies 35D arranged substantially point-symmetrically with respect to the central portion of the contact member 18, since it is possible to disperse the contact area between the magnetic bodies 35D and the portion generating the magnetic force of the mounting machine other machines can be dispersed at the time of transportation, attachment and detachment of the transducer 2E conducted by the mounting machine other machines using magnetic attraction, the magnetic force (attractive force) applied to the transducer 2E can be dispersed.

According to the fifth modification example, a transducer, which is an example of a mounting component, suppressing state changes such as breakage, deformation, and changes in characteristics can be provided because the magnetic force (attractive force) is more uniformly applied to the transducer.

### Sixth Modification Example

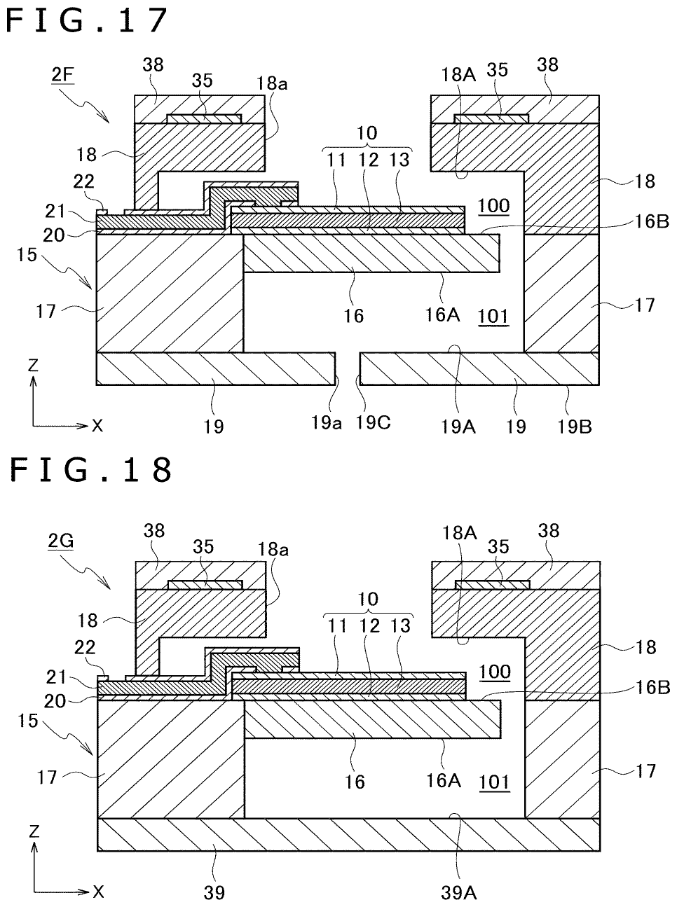

The configuration of a transducer 2F in this modification example will be described with reference to FIG. 17. FIG. 17 is a cross-sectional view of the transducer 2F sectioned in the X-direction. The transducer 2F in this modification example is different from the transducer 2 illustrated in FIGS. 5 and 6 in that a base material 38 is further provided on the contact member 18 and the magnetic bodies 35. In this modification example, the above description is used for reference regarding the points common to the transducer 2 illustrated in FIGS. 5 and 6, and different points will be described below.

The base material 38 has a function of protecting the magnetic bodies 35 or other components from the outside. For the transportation, attachment and detachment of the transducer 2F by a mounting machine other machines using magnetic attraction, the base material 38 absorbs an external impact or other physical phenomenon caused by the mounting machine other machines and can suppress the influence of impact etc. from the outside into the inside of the transducer 2F such as the magnetic bodies 35.

The base material 38 may be made of Si or a soft material such as resin, for example, and in particular, is preferably made of a soft material such as resin from the viewpoint of absorbing external impacts etc. Further, at the time of transportation, attachment and detachment of the transducer 2F, since the magnetic bodies 35 is attracted through the base material 38 by the magnetic force generated by the mounting machine, it is necessary to adjust the properties of the magnetic bodies 35 and the base material 38, and the magnetic force generated by the mounting machine such that the magnetic bodies 35 and the base material 38 are affected by the magnetic force generated by the mounting machine, and, for example, the magnetic properties of the magnetic bodies 35, a thickness of the base material 38 and magnetic force generated by the mounting machine can be adjusted.

In addition, since the magnetic bodies 35 is provided on the contact member 18 similarly to the transducer 2 in the second embodiment, and transportation, attachment and detachment are carried out by a mounting machine other machines that uses magnetic attraction, stress due to vacuum suction does not occur in the vibrating membrane 16. Due to this, the shape deformation or breakage of the vibrating membrane 16 can be suppressed.

According to the sixth modification example, a transducer, which is an example of a mounting component, suppressing state changes such as breakage, deformation, and changes in characteristics can be provided.

### Seventh Modification Example

The configuration of a transducer 2G in this modification example will be described using FIG. 18. FIG. 18 is a cross-sectional view of the transducer 2G sectioned in the X-direction. The transducer 2G in this modification example is different from the transducer 2A illustrated in FIGS. 7 and 8 in that the base material 38 is further provided on the contact member 18 and the magnetic bodies 35. In this modification example, the above description is referenced regarding the points common to the transducer 2A illustrated in FIGS. 7 and 8, and different points will be described below.

Similarly to the transducer 2F in the sixth modification example of the second embodiment, when the transportation, attachment and detachment of the transducer 2G is conducted by a mounting machine other machines using magnetic attraction, the base material 38 absorbs external impacts etc. caused by the mounting machine other machines and can suppress the influence of external impacts etc. to the inside of the transducer 2G such as the magnetic bodies 35. Furthermore, since the transducer 2G has the magnetic bodies 35 provided on the contact member 18, and transportation, attachment and detachment are carried out by a mounting machine other machines using magnetic attraction, no stress is generated in the vibrating membrane 16 due to vacuum suction. As a result, the shape deformation or breakage of the vibrating membrane 16 can be suppressed.

According to the seventh modification example, a transducer, which is an example of a mounting component, suppressing state changes such as breakage, deformation, and changes in characteristics can be provided.

### Eighth Modification Example

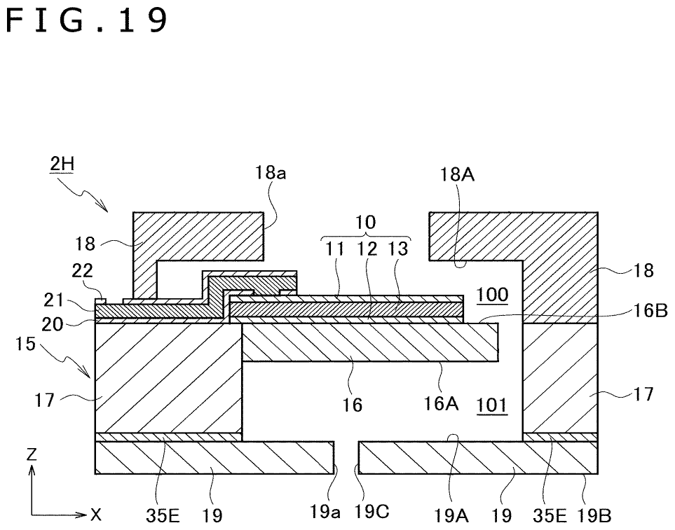

The configuration of a transducer 2H in this modification example will be described with reference to FIG. 19. FIG. 19 is a cross-sectional view of the transducer 2H sectioned in the X-direction. The transducer 2H in this modification example is different from the transducer 2 illustrated in FIGS. 5 and 6 in that magnetic bodies 35E arranged between the base material 19 and the membrane support 17 is provided instead of the magnetic bodies 35. In this modification example, the above description is used for reference for the points common to the transducer 2 illustrated in FIGS. 5 and 6, and different points will be described below.

The material of the magnetic bodies 35E is not particularly limited as long as an upward attractive force is generated due to the magnetic force. Examples thereof include iron, nickel, cobalt, gadolinium, iron oxide, chromium oxide, and ferrite. In addition, from the viewpoint of easy formation, the magnetic bodies 35E preferably include coating films made of magnetic ink obtained by coating the base material 19 or the membrane support 17 with the magnetic ink containing a material mentioned above.

Also, instead of the magnetic body 35E, the base material 19 that generates an upward attractive force due to magnetic force may be used. To be specific, the base material 19 generating an attractive force due to magnetic force can be obtained by causing the material constituting the base material 19 to include iron, nickel, cobalt, gadolinium, iron oxide, chromium oxide, ferrite, or other elements to form the base material 19. When using the base material 19 that generates an attractive force due to magnetic force, it is sufficient only if the base material 19 is attracted by the magnetic force generated by the mounting machine at the time of attachment and detachment of the transducer.

The transducer 2H has the magnetic body 35E provided on the base material 19, and since transportation, attachment and detachment are performed by a mounting machine other machines that uses magnetic attraction, no stress is generated in the vibrating membrane 16 due to vacuum suction. Due to this, the shape deformation or breakage of the vibrating membrane 16 can be suppressed.

Further, in order to disperse the magnetic force (attractive force) applied to the transducer 2H, the magnetic body 35E may surround the periphery of the opening 19a of the base material 19, similarly to the transducer 2B in the second modification example of the second embodiment. Further, similarly to the transducer 2C in the third modification example of the second embodiment, the magnetic body 35E may be arranged in the entire area where the base material 19 and the membrane support 17 overlap each other. Still further, similarly to the transducer 2D in the fourth modification example of the second embodiment, the magnetic bodies 35E may be arranged on the upper surfaces of the four corners of the base material 19 when viewed from the membrane thickness direction (Z-direction). Moreover, similarly to the transducer 2E in the fifth modification example of the second embodiment, the magnetic bodies 35E may be arranged point-symmetrically with respect to the center of the base material 19.

According to the eighth modification example, a transducer, which is an example of a mounting component, suppressing changes in state such as breakage, deformation, and changes in characteristics can be provided.

### <Electronic Device>

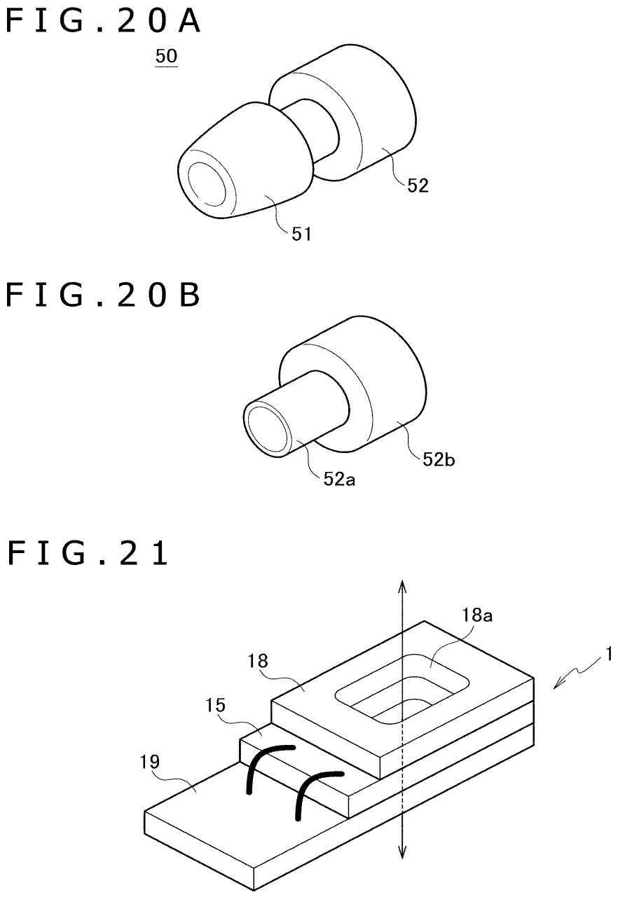

An electronic device according to the present embodiment will be described. An electronic device according to the present embodiment has a speaker unit and a housing that houses the speaker unit. An example of an electronic device is an earphone. An earphone 50 illustrated in FIG. 20A has an earpiece 51 and a housing 52.

FIG. 20B is a diagram illustrating the shape of the housing 52 after the earpiece 51 has been removed from the earphone 50. The housing 52 has a cylindrical shape having a bottom and has a tubular portion 52a and a bottom portion 52b in contact with the tubular portion 52a. A speaker unit is arranged in a part of the tubular portion 52a and a part of the bottom portion 52b. The arrangement of the housing 52 and the speaker unit (mounting of the speaker unit) will be described below.

### (Mounting Example)

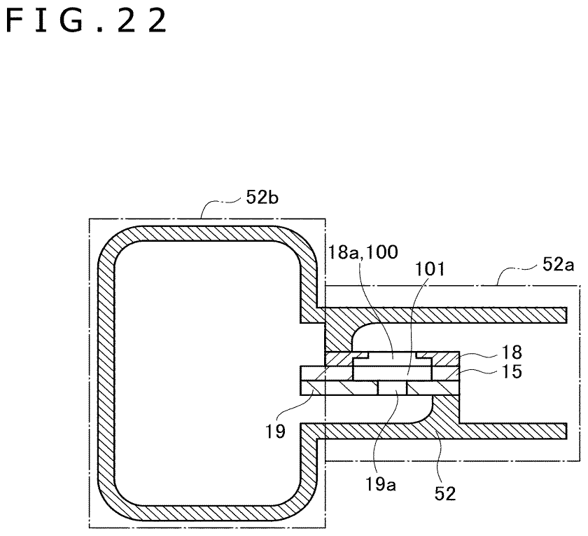

As illustrated in FIG. 21, the speaker unit (transducer 1) has a configuration in which the membrane body 15 and the contact member 18 are provided on the base material 19. A ventilation hole (specifically, opening 18a or opening 19a illustrated in FIGS. 21 and 22) is provided in the membrane thickness direction (the direction indicated by the arrows in the figure) of the transducer 1 (base material 19, membrane body 15, and contact member 18).

FIG. 22 is a cross-sectional view of an earphone in which the transducer 1 is mounted in the housing 52. The base material 19 is arranged on a part of the tubular portion 52a and a part of the bottom portion 52b, and the membrane body 15 and the contact member 18 are provided on the base material 19. The base material 19 has the opening 19a and the contact member 18 has the opening 18a. The membrane body 15 includes the vibrating membrane 16 and the membrane support 17. The bottom portion 52b is separated from the tubular portion 52a via the transducer 1, and the space of the bottom portion 52b and the outside of the housing 52 are communicated with each other via the openings 18a and 19a. For the transducer 1 in this mounting example, the transducer 1 in the first embodiment illustrated in FIGS. 1 and 2 can be used, for example, and the space of the bottom portion 52b and the outside of the housing 52 communicate with each other through the opening 18a, the space 100, the space 101, and the opening 19a.

By adopting a structure in which the tubular portion 52a and the bottom portion 52b are separated through the transducer 1, the air flow between the tubular portion 52a and the bottom portion 52b is blocked. Due to this, the housing 52 can be utilized as a space for mounting other devices, a battery, or other components, and the housing 52 can be miniaturized.

### Other Embodiments

While several embodiments have been described above, the statements and drawings forming part of the disclosure are to be understood as illustrative and not limiting. Various alternative embodiments, practical examples and operational techniques will become apparent to those skilled in the art from this disclosure.

For example, the transducer may be applied to receive sound waves as well as to transmit sound waves. Moreover, the transducer may be applied to applications for transmitting or receiving not only sound waves but also ultrasonic waves. Furthermore, not limited to transducers, even regarding a small-sized component having an opening at the top and a thin membrane-shaped member inside, which undergoes or is likely to undergo a change in state such as destruction, deformation or change in properties of the membrane-shaped member due to a change in internal air pressure because of suction from the opening, the same effect as described in the above embodiments can be obtained by providing a cover or a magnetic body.

What is claimed is:

1. A mounting component held so as to be capable of attachment and detachment by a mounting machine, the mounting component comprising:
a membrane support;
a vibrating membrane connected to the membrane support and displaceable in a membrane thickness direction;
a contact member that is located on the membrane support and is subjected to an upward attractive force by the mounting machine without generating stress leading to shape deformation or breakage of the vibrating membrane during the attachment and the detachment, wherein the contact member has a first opening; and
a magnetic body on the contact member, wherein the magnetic body surrounds the first opening.

2. The mounting component according to claim 1, wherein the upward attractive force due to magnetic force is applied to the contact member and the magnetic body during the attachment and the detachment.

3. The mounting component according to claim 2, further comprising: a first base material on the contact member.

4. The mounting component according to claim 2, wherein the magnetic body covers an entire upper surface of the contact member.

5. The mounting component according to claim 2, wherein
the magnetic body is located at each of points arranged point-symmetrically with respect to a center of the contact member when viewed in the membrane thickness direction.

6. The mounting component according to claim 2, wherein the magnetic body is provided on an upper surface of each of four corners of the contact member.

7. The mounting component according to claim 2, wherein the magnetic body includes a coating film made of magnetic ink.

8. A mounting component held so as to be capable of attachment and detachment by a mounting machine, the mounting component comprising:
a membrane support;
a vibrating membrane connected to the membrane support and displaceable in a membrane thickness direction;
a contact member that is located on the membrane support and is subjected to an upward attractive force by the mounting machine without generating stress leading to shape deformation or breakage of the vibrating membrane during the attachment and the detachment;
a second base material having a facing surface facing the vibrating membrane; and
a magnetic body disposed between the second base material and the membrane support, wherein the upward attractive force due to magnetic force is applied to the contact member, the membrane support, and the magnetic body during the attachment and the detachment.
